(19) United States
(12) Patent Application Publication
(10) Pub. No.: US 2023/0365158 A1
(43) Pub. Date: Nov. 16, 2023

(54) DETERMINING A MINIMAL RISK MANEUVER FOR A VEHICLE

(71) Applicant: Robert Bosch GmbH, Stuttgart (DE)

(72) Inventor: Andreas Heyl, Weil Der Stadt (DE)

(21) Appl. No.: 18/187,145

(22) Filed: Mar. 21, 2023

(30) Foreign Application Priority Data
May 12, 2022 (DE) 10 2022204 667.6

(51) Int. Cl. B60W 60/00; B60W 40/02

(52) U.S. Cl. CPC B60W 60/0011; B60W 60/0015; B60W 40/02; B60W 2556/45

(57) ABSTRACT

A method for determining a minimal risk maneuver (MRM) on a route in order to obtain a minimal risk condition (MRC) for a vehicle. The method includes: determining a first proposal for at least one part of the MRM to be determined, wherein the first proposal is ascertained from data from a first, on-board data source of the vehicle; determining a second proposal for the at least one part of the MRM to be determined, wherein the second proposal is ascertained from data from at least one second, off-board data source; aggregating the first proposal and the second proposal into the at least one part of the MRM, and/or selecting the first proposal or the second proposal as this at least one part of the MRM, on the basis of a predetermined evaluation criterion.

### CROSS REFERENCE

The present application claims the benefit under 35 U.S.C. § 119 of German Patent Application No. DE 10 2022 204 667.6 filed on May 12, 2022, which is expressly incorporated herein by reference in its entirety.

### FIELD

The present invention relates to a method for determining a minimal risk maneuver (MRM) on a route in order to obtain a minimal risk condition (MRC) for a vehicle.

### BACKGROUND INFORMATION

In an automated driving system (ADS) for a vehicle, safety standards are implemented which require a minimal risk maneuver (MRM) to be performed when safety-relevant errors occur in order to obtain a safe vehicle state. This safe state is also called a minimal risk condition (MRC).

U.S. patent application Publication No. US 2021/0294336 A1 describes a method for selecting an MRM having the lowest risk level from a number of proposals for possible MRMs for a vehicle.

U.S. patent application Publication No. US 2019/118827 A1 describes a method in which a first MRC event recommendation is generated by a first platform controller and a second MRC event recommendation is generated by a second platform controller, and the first or the second MRC event recommendation being selected as the selected MRC event.

As demonstrated by the related art, until now, in current ADS systems an MRM and the MRC have been determined only in the vehicle, because all the relevant information for determining these functions is usually only found in the vehicle.

### SUMMARY

The present invention provides a method for determining a minimal risk maneuver (MRM) on a route in order to obtain a minimal risk condition (MRC) for a vehicle. According to an example embodiment of the present invention, the method comprises the following steps:
In a first step, a first proposal is determined for at least one part of the MRM to be determined, wherein the first proposal is ascertained from data from a first, on-board data source of the vehicle.
In a second step, a second proposal is determined for the at least one part of the MRM to be determined, wherein the second proposal is ascertained from data from at least one second, off-board data source.
In a third step, the first proposal and the second proposal are aggregated into the at least one part of the MRM, and/or the first proposal or the second proposal is selected as this at least one part of the MRM, on the basis of a predetermined evaluation criterion.

The basic concept of the present invention is that a final MRM can be compiled from different proposals for at least one part of the final MRM along a vehicle route until a minimal risk condition (MRC) is obtained, it always being possible to select the proposals for an MRM that are currently the safest, i.e., those calculated on the basis of the most reliable information.

In this case, the proposals for at least one part of the final MRM to be determined can be generated and provided by different components and systems which use both on-board data sources and off-board data sources. A proposal to form a part of the MRM is then selected using a predetermined evaluation criterion.

In this way, determining the MRM is not limited only to on-board data sources, such as vehicle sensor data. If an MRM that is safer than the MRM that can be ascertained on the basis of the information from on-board data sources can therefore be determined using off-board data sources and off-board resources, the vehicle can benefit from this increased level of safety. By way of example, tunnels are usually monitored by cameras in an uninterrupted manner from a traffic control center. The traffic control center thus has comprehensive knowledge of the traffic situation, even in regions in which the vehicle will arrive shortly and are still outside the detection range of sensors on the vehicle. If, in a tunnel in which there is oncoming traffic, for example, the traffic control center knows definitively that another vehicle is not coming toward the vehicle in the opposite lane, it can create an MRM that brings the vehicle to a stop in the opposite lane, or it can cause the vehicle to create an MRM of this kind. At the same time, the traffic control center can then block the entrance to the tunnel at which vehicles in the opposite lane would normally enter.

At the same time, providing two proposals ensures that, even in the event of a failure or malfunction of an on-board or off-board system while the MRM is being ascertained, it is still always possible to provide a safe MRM which can be reliably drawn upon if a safety-relevant event for the vehicle occurs. In particular, the use of off-board data sources and resources thus no longer fails because of the “primal fear” that these resources or the communication between them and the vehicle will not always be available in an uninterrupted manner. For instance, in said tunnel the wireless network connection of the vehicle can sometimes drop out.

A possible configuration of the method of the present invention provides that the vehicle is actuated in order to execute the at least one part of the MRM. As a result, it is ensured that the vehicle is always transferred into a safe state if a safety-relevant event occurs.

In a further possible configuration of the method of the present invention, the data for the at least second, off-board data source are used from at least one of the following sources: sensor data from an external vehicle, infrastructure data from an external edge system, data from an external cloud system, or geographical map data. As a result, a safe MRM that is not based on, or is not solely based on, the provision of on-board data, or is not only dependent thereon, can advantageously be determined for the vehicle. This also increases an error tolerance of the provided data which are used to ascertain the MRM. The expression “make an informed decision on the MRM” means that this decision has a better basis the more data sources that are used and can supplement one another.

A possible configuration of the method of the present invention provides that the MRM to be determined is divided into at least one on-board part ascertained only from data from the first, on-board data source of the vehicle, and at least one externalizable part, for which the first proposal and the second proposal are ascertained. This provides the advantage that the safest MRM in each case can always be determined in a flexible and efficient manner on the basis of a current vehicle situation, a current vehicle state, or a dynamic environment. In addition, for example, the on-board determination of the MRM can be approved by authorities as the minimum safety standard to be ensured and, in this respect, can be prevented from being changed, while at the same time there is freedom to increase the level of safety yet further by way of the externalizable part. This externalizable part then no longer has to be approved by authorities, since, in the event of an error, the on-board determination of the MRM still takes effect.

A possible configuration of the method of the present invention provides that the second proposal is ascertained at a central data-processing facility responsible for a plurality of vehicles or at a plurality of data-processing facilities of this kind in parallel. This provides the advantage of efficient resource usage and resource utilization. For example, a traffic control center that monitors all the vehicles in a tunnel can reuse results that have been obtained on one occasion multiple times when ascertaining second proposals for MRMs for all of these vehicles.

A further possible configuration of the method of the present invention provides that the time scale of the MRM to be determined is incorporated in the predetermined evaluation criterion for the proposals and/or in a criterion for dividing the MRM into the on-board part and the externalizable part. This provides the advantage that, when ascertaining the MRM, it is possible to respond flexibly to a volatile environment. In addition, as in the above-mentioned example of the tunnel, there is an increased probability of off-board data sources and entities having a better overview of route sections that are further in the future on the way to the MRC. For instance, a surround sensor system on the vehicle cannot see around the next corner.

In a further possible configuration of the method of the present invention, at least one indicator of the reliability of the first proposal and/or the second proposal is incorporated in the predetermined evaluation criterion for the proposals and/or in a criterion for switching at least one data source. This provides the advantage that the safest and most reliable MRM for the vehicle is ascertained at any point in time.

In a further possible configuration of the method of the present invention, the indicator of the reliability comprises at least one of the following parameters: the safety integrity of the information, the degree of reliability or variance of the provided information, and the risk level of the final ascertained MRM over a defined duration. This provides the advantage that the safest and most reliable MRM for the vehicle is ascertained at any point in time.

A possible configuration of the method of the present invention further provides that, in response to a change in an environmental or behavioral condition for the vehicle, the final MRM and/or the selected data source for determining at least one proposal is adjusted in real time over the route until the MRC is obtained. This provides the advantage that a changing environmental or behavioral condition for the vehicle can be taken into account directly and promptly when ascertaining the safest and most reliable MRM for the vehicle in each case along the route. In this way, the vehicle safety can be adjusted along the route flexibly and rapidly to the relevant environmental or behavioral condition for the vehicle.

A possible configuration of the method of the present invention further provides that adjusting the final MRM includes re-starting the method for at least one part of the MRM. This provides the advantage that the most up-to-date data are always used when ascertaining the final MRM. This results in increased vehicle safety.

Furthermore, a possible configuration of the method of the present invention provides that an MRC is ascertained together with the final MRM or from the final MRM. As a result, the vehicle safety can be increased in a flexible manner. In addition, the interdependence between the MRM and the MRC can be taken into account. For instance, the MRC influences the MRM at least by way of the boundary condition whereby the MRC has to be present at the end of the final MRM. Conversely, when calculating MRMs, it might become apparent that a desired MRC cannot be obtained. For example, an emergency stop bay intended for an MRC on the basis of digital map material can be temporarily closed off because there is construction material in it.

The present invention can be computer-implemented in full or in part and can thus be embodied in software. Therefore, the present invention also relates to a computer program containing machine-readable instructions which, when executed on one or more computers and/or computer instances, cause the computer(s) or computer instance(s) to carry out the method described above. Computer instances can be virtual machines, containers, or serverless execution environments, for example.

In addition, the present invention also relates to a machine-readable data medium and/or a download product comprising the computer program. A download product is a digital product that can be transmitted over a data network, i.e., downloaded by a user of the data network, and, for example, can be offered for sale for immediate download in an online shop.

Further measures that enhance the present invention will be set out in more detail below together with the description of the preferred exemplary embodiments of the present invention with reference to figures.

### BRIEF DESCRIPTION OF THE DRAWINGS

FIG. 1 is a schematic flow chart of the method 100 for determining a minimal risk maneuver (MRM), according to an example embodiment of the present invention.

FIG. 2 shows an exemplary application of the method 100 for providing proposals from on-board and off-board data sources for forming an MRM for a vehicle 1, according to an example embodiment of the present invention.

FIG. 3 is an exemplary representation for forming a final MRM from a first proposal 14 and a second proposal 16, according to an example embodiment of the present invention.

FIG. 4 is an exemplary representation of the risk level of different proposals for forming an MRM as a function of time, according to an example embodiment of the present invention.

### DETAILED DESCRIPTION OF EXAMPLE EMBODIMENT

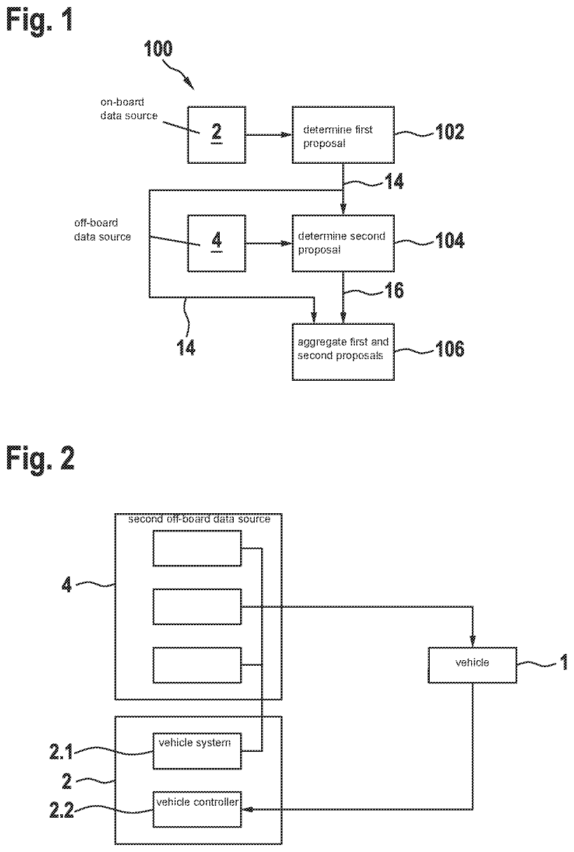

FIG. 1 is a schematic flow chart of the method 100 for determining a minimal risk maneuver (MRM) in order to obtain a minimal risk condition (MRC) for a vehicle 1.

In step 102, a first proposal 14 is determined for at least one part of the MRM to be determined, wherein the first proposal 14 is ascertained from data from a first, on-board data source 2 of the vehicle 1.

In step 104, a second proposal 16 is determined for the at least one part of the MRM to be determined, wherein the second proposal 16 is ascertained from data from at least one second, off-board data source 4.

In step 106, the first proposal and the second proposal are aggregated into the at least one part of the MRM, and/or the first proposal or the second proposal is selected as this at least one part of the MRM, on the basis of a predetermined evaluation criterion.

FIG. 2 shows an exemplary application of the method 100 for providing different proposals from on-board and off-board data sources for forming an MRM for a vehicle 1.

In this figure, by way of example, the block 2 contains a vehicle system 2.1 and a vehicle controller 2.2 of the vehicle 1. In this case, the vehicle system 2.1 can be an ADS system, which, connected to the corresponding vehicle sensor system of the vehicle 1, constitutes a first, on-board data source 2 and provides on-board data for forming a first proposal for at least one part of the MRM to be determined.

By way of example, the block 4 constitutes a second, off-board data source 4. This second data source 4 can provide data from an off-board data source and/or from a plurality of off-board data sources in order to determine a second proposal for the at least one part of the MRM to be determined.

In this case, the off-board data sources 4 can, for example, be sensor data and algorithms from at least one external vehicle located in the vicinity of the vehicle 1; however, infrastructure data from an external edge system or data from an external cloud system, in which vehicle data or data from the ADS system of the vehicle 1 are stored, for example, can also be used. Furthermore, geographical map data can be taken into account which, for example, provide or generate corresponding data on the basis of MRM trajectories or MRCs previously defined for certain positions on a route 12 of the vehicle 1. It would also be possible to incorporate data from user devices, such as smartphones and tablets, in the determination of a second proposal.

The first proposal and/or second proposal, generated in this way, for a part of the MRM is then supplied to a vehicle controller 2.2 of the vehicle 1. The vehicle controller 2.2 then determines the final MRM for a predetermined MRC on the route 12 to be taken by the vehicle 1 in the following manner: the first proposal and the second proposal are aggregated, i.e., combined, into at least one part of the MRM and/or the first proposal or the second proposal is selected as this at least one part of the MRM on the basis of a predetermined evaluation criterion.

In the present invention, the final MRM is thus composed of different proposals for a part of the MRM, the data for which can come from both on-board and off-board data sources.

The vehicle controller 2.2 decides, on the basis of a predetermined evaluation criterion, whether and to what extent on-board data sources should be used and/or whether and to what extent partial or full externalization to off-board systems for use with off-board data sources connected to these systems should be implemented to determine at least one part of the MRM for forming a final MRM.

This evaluation criterion can be formed from an item of information or a plurality of items of information. Some non-limiting examples are given in the following to illustrate this:
the level of safety integrity of the available information in accordance with the automotive safety integrity level (ASIL),
the level of confidence of the provided information, i.e., the reliability of the available information taking into account the functional inadequacies (SOTIF) of the data and algorithms used,
taking into account a variance of the values of the parameters of safety integrity and confidence as a function of time along the route 12 to be taken by the vehicle 1, for example on the basis of the increase in “uncertainty” with regard to future dynamic states of vehicle components, which, as a result, can lead to an increase in the estimated risk of collision,
the level of reliability of the route 12 of the vehicle 1, because portions of the entire route 12 are not sufficiently reliably perceived by the vehicle system 2.1 of the vehicle 2 or another system.
Furthermore, a superordinate policy could also specify or prioritize the selection of a certain proposal for an MRM or a part of the MRM, e.g., for insurance reasons.

Additionally or alternatively, a time scale of the MRM to be determined can also be incorporated in the predetermined evaluation criterion for the proposals and/or in a criterion for dividing the MRM into the on-board part and the externalizable part. For example, this is to be understood as follows:

For the scenario in which the MRC and the MRM are determined as a matter of priority in the vehicle or in the ADS system of the vehicle, owing to the duration of the ascertained MRM—for example, the travel time of the vehicle to the parking bay is two minutes—the quality or safety of this MRM may be insufficient or may decrease over the duration of the maneuver over the route to be taken by the vehicle and the uncertainty and the risk of collision of the vehicle estimated thereby may increase owing to the dynamic environment. In this case, it would then possibly be safer to switch to an MRM determined by external systems.

In addition, at least one indicator of the reliability of the first proposal 14 and/or the second proposal 16 can be incorporated in the predetermined evaluation criterion for the proposals 14, 16 and/or in a criterion for switching at least one data source 2, 4. As a result, the vehicle safety can be increased.

In this case, the indicator of the reliability comprises at least one of the following parameters: the safety integrity of the information, the degree of reliability or variance of the provided information, and the risk level of the final ascertained MRM over a defined duration.

In principle, a so-called intrinsically safe system is sought. This means that the ADS system of the vehicle 1 determines the MRC and the MRM autonomously; however, the capabilities of the ADS are potentially severely limited, and therefore it is advantageous to draw upon information from an external source or even to determine the MRM externally.

For this purpose, the vehicle controller 2.2 of the vehicle 1 can contain a so-called MRM manager (not shown in FIG. 2), which takes this decision as to whether and to what extent functions for determining the MRM and/or the MRC should be externalized.

In this way, at any point in time on the entire route 12 taken by the vehicle 1, the safest and most reliable available MRC and/or the safest and most reliable available MRM are selected, and specifically for normal operation or in the event of an error that occurs, for example in the event of a failure of the ADS system or the vehicle sensor system of the vehicle 1, which is required both for safe operation and for determining the MRM.

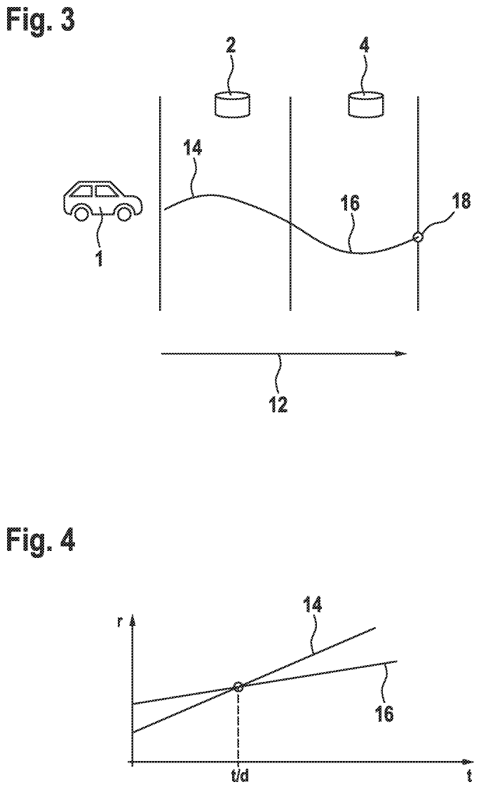

FIG. 3 is an exemplary representation for forming a final MRM from a first proposal 14 and a second proposal 16 for a vehicle 1. In this exemplary embodiment, the final MRM that is determined in order to safely and reliably obtain the minimal risk condition 18 for a route 12 to be taken is composed of a first proposal 14 and a second proposal 16. The first proposal 14 is ascertained from data from a first, on-board data source 2. The second proposal 16 is ascertained from data from a second, off-board data source 4, which is externalized. The second proposal 16 can, for example, then be ascertained when it is established that there is a better-quality data situation in an external system than in the vehicle 1, and therefore better results can be expected.

In this case, the second proposal can be ascertained at a central data-processing facility responsible for a plurality of vehicles, for example in the vehicle 1 itself or in an edge system or cloud system, or at a plurality of data-processing facilities of this kind in parallel, i.e., in the vehicle 1, in other vehicles, in an edge or cloud system, or in a smart device.

In response to a change in an environmental or behavioral condition for the vehicle 1, the final MRM and/or the selected data source 2, 4 for determining the at least one proposal can be adjusted in real time over the route until the MRC is obtained. In this case, adjusting the final MRM can also mean re-starting the method for determining at least one part of the MRM.

The present invention can also provide that an MRC is ascertained together with the final MRM or from the final MRM. The decision as to whether and to what extent information from on-board or off-board data sources should be used to ascertain an MRC for the vehicle 1 can be taken analogously using the above-described method.

FIG. 4 is a schematic graph showing an exemplary representation of the risk level of different proposals 14, 16 for forming an MRM as a function of time in each case. The risk level r is plotted on the y axis, and the x axis corresponds to the duration t. The line 14 corresponds to a first proposal 14 having a corresponding and ascertained MRM 1. The line 16 corresponds to a second proposal 16 having a corresponding and ascertained MRM 2.

It can be generally understood from this graph that the risk r associated with a proposal having an MRM ascertained from different data sources can vary over time. Therefore, at the point of intersection t/d of the two lines or proposals 14 and 16, it may make sense to consider temporarily switching from MRM 1 (formed on the basis of the first proposal 14) to an MRM 2 (formed on the basis of the second proposal 16) for safety reasons.

What is claimed is:

1. A method for determining a minimal risk maneuver (MRM) on a route to obtain a minimal risk condition (MRC) for a vehicle, comprising the following steps:
determining a first proposal for at least one part of the MRM to be determined, wherein the first proposal is ascertained from data from a first, on-board data source of the vehicle;
determining a second proposal for the at least one part of the MRM to be determined, wherein the second proposal is ascertained from data from at least one second, off-board data source; and
aggregating the first proposal and the second proposal into the at least one part of the MRM, and/or selecting the first proposal or the second proposal as the at least one part of the MRM, based on a predetermined evaluation criterion.

2. The method as recited in claim 1, wherein the vehicle is actuated to execute the at least one part of the MRM.

3. The method as recited in claim 1, wherein the data for the at least second, off-board data source are used from at least one of the following sources: sensor data from an external vehicle, or infrastructure data from an external edge system, or data from an external cloud system, or geographical map data.

4. The method as recited in claim 1, wherein the MRM to be determined is divided into at least one on-board part ascertained only from data from the first, on-board data source of the vehicle, and at least one externalizable part, for which the first proposal and the second proposal are ascertained.

5. The method as recited in claim 1, wherein the second proposal is ascertained at a central data-processing facility responsible for a plurality of vehicles or at a plurality of data-processing facilities responsible for a plurality of vehicles in parallel.

6. The method as recited in claim 4, wherein a time scale of the MRM to be determined is incorporated in the predetermined evaluation criterion for the first and second proposals and/or in a criterion for dividing the MRM into the on-board part and the externalizable part.

7. The method as recited in claim 1, wherein at least one indicator of a reliability of the first proposal and/or the second proposal is incorporated in the predetermined evaluation criterion for the proposals and/or in a criterion for switching at least one data source.

8. The method as recited in claim 7, wherein the indicator of the reliability includes at least one of the following parameters: a safety integrity of provided information, a degree of reliability or variance of the provided information, a risk level of the ascertained MRM over a defined duration.

9. The method as recited in claim 1, wherein in response to a change in an environmental or behavioral condition for the vehicle, a final MRM and/or a selected data source for determining at least one of the first and second proposals is adjusted in real time over the route until the MRC is obtained.

10. The method as recited in claim 9, wherein adjusting the MRM includes re-starting the method for at least one part of the MRM.

11. The method as recited in claim 1, wherein an MRC is ascertained together with a final MRM or from a final MRM.

12. A non-transitory machine-readable data medium on which s stored a computer program for determining a minimal risk maneuver (MRM) on a route to obtain a minimal risk condition (MRC) for a vehicle, the computer program, when executed by one or more computers and/or computer instances, cause the one or more computers and/or computer instances to perform the following steps:
determining a first proposal for at least one part of the MRM to be determined, wherein the first proposal is ascertained from data from a first, on-board data source of the vehicle;
determining a second proposal for the at least one part of the MRM to be determined, wherein the second proposal is ascertained from data from at least one second, off-board data source; and
aggregating the first proposal and the second proposal into the at least one part of the MRM, and/or selecting the first proposal or the second proposal as the at least one part of the MRM, based on a predetermined evaluation criterion.

13. One or more computers and/or computer instances for determining a minimal risk maneuver (MRM) on a route to obtain a minimal risk condition (MRC) for a vehicle, the one or more computers and/or computer instances configured to:
determine a first proposal for at least one part of the MRM to be determined, wherein the first proposal is ascertained from data from a first, on-board data source of the vehicle;
determine a second proposal for the at least one part of the MRM to be determined, wherein the second proposal is ascertained from data from at least one second, off-board data source; and
aggregate the first proposal and the second proposal into the at least one part of the MRM, and/or selecting the first proposal or the second proposal as the at least one part of the MRM, based on a predetermined evaluation criterion.
